(19) United States
(12) Patent Application Publication
(10) Pub. No.: US 2001/0044877 A1
(43) Pub. Date: Nov. 22, 2001

(54) Raid-type library apparatus using cartridge storing a plurality of storage media and method for controlling the library apparatus

(76) Inventors: Takashi Kanazawa, Kanagawa-ken (JP); Hiroyuki Suzuki, Kanagawa-ken (JP); Norio Matsuno, Kanagawa-ken (JP)

Correspondence Address: David L. Fehrman, Morrison & Foerster LLP, 35th Floor, 555 W. 5th Street, Los Angeles, CA, 90013, US

(21) Appl. No.: 09/859,560

(22) Filed: May 17, 2001

(30) Foreign Application Priority Data
May 17, 2000 (JP) 2000-144755

(51) Int. Cl. G06F 12/00

(52) U.S. Cl. 711/111; 711/170

(57) ABSTRACT

There are provided a cartridge transport mechanism that sequentially transports a media cartridge, capable of storing a plurality of storage media, to predetermined positions corresponding to a plurality of library units, and a control device that performs control for passing a predetermined number of the storage medium between the media storage section or drive device of each of the library units and the media cartridge sequentially transported to the predetermined position corresponding to the library unit. As the media cartridge is sequentially transported to the predetermined positions, the library units each receive or send the predetermined number of the storage medium from or to the media cartridge. Because all of the storage media of a same RAID group that are stored or to be stored dividedly in and across the library units can be stored together in a same media cartridge allocated to that RAID group, a user can collectively manage the storage media of each RAID group just through the use of the media cartridge.

### BACKGROUND OF THE INVENTION

The present invention relates generally to media library array apparatus which comprise an array of library units each including a media storage section for storing a number of transportable storage media, a drive device for writing or reading data to or from a storage medium inserted or mounted therein and a holder/transporter for holding and transporting a designated storage medium to a designated place within the library unit, as well as methods for controlling such media library array apparatus. More particularly, the present invention concerns a novel technique for collectively managing a plurality of storage media, belonging to a same RAID (acronym for Redundant Array of Inexpensive Disks), on a cartridge-by-cartridge basis, to thereby enhance integrity of data recorded dividedly across the plurality of storage media.

In the field of electronic libraries and other types of computer systems, there have heretofore been used high-capacity and high-performance media library array apparatus. Among known examples of the high-capacity and high-performance media library array apparatus is one which comprises a plurality of similarly-constructed library units configured in a redundant array. Each of the similarly-constructed library units includes a medium entry port (hereinafter called a “mass entry port”) through which a desired storage medium is introduced into or discharged out of the library unit, a media storage section (also known as a “magazine”) for removably storing a multiplicity of transportable disk-shaped storage media, such as CDs (acronym for Compact Disks) and DVDs (acronym for Digital Versatile Disks), one or more drive devices for driving, i.e. writing or reading data to or from, a designated storage medium, and a holder/transporter for automatically transporting a designated storage medium between the mass entry port, media storage section and drive device. As one example of that type of media library array apparatus, there has been known a disk library array apparatus which is commonly called a RAIL (Redundant Arrays of Inexpensive Libraries) apparatus. By operating the plurality of library units concurrently in a parallel manner, the RAIL apparatus can, at high speed, store (write) desired data dividedly onto respective designated disks in the individual library units and then read the thus dividedly-stored data from the disks. In such a disk library array apparatus capable of recording and reproducing data to and from the removable and transportable disks in the parallel manner, it is necessary to collectively manage the plurality of storage media, to be processed in parallel, as a set of volumes (hereinafter referred to as a RAID group).

More specifically, the known disk library array apparatus is arranged to allow a media cartridge, capable of storing a plurality of storage media, to be introduced or discharged into or from the library units through the respective mass entries; thus, the plurality of the storage media belonging to different RAID groups can be introduced or discharged into or from the individual library units in a successive fashion. However, with the known disk library array apparatus where the storage media of different RAID groups are stored in a mixture in one media cartridge and thus even a predetermined number of the storage media belonging to a same RAID group are stored separately in different media cartridges, it is very difficult, if not impossible, to collectively manage the predetermined number of the storage media belonging to the same RAID group and manage the storage media of each RAID group independently of the storage media of the other RAID groups, which would thus cause great inconvenience to a user.

### SUMMARY OF THE INVENTION

It is therefore an object of the present invention to provide an improved media library array apparatus and control method therefor which can collectively manage a plurality of storage media of a same media group just through the use of a media cartridge, by causing the storage media of the same group to be stored together in the same media cartridge and to be passed between the same media cartridge and each of a plurality of library units for introduction or discharge to or from the library unit.

It is another object of the present invention to provide an improved media library array apparatus and control method therefor which allows a plurality of storage media of a same group to be always stored in a same media cartridge, by confirming that all storage media to be passed between the media cartridge and library units are of the same group.

According to one aspect of the present invention, there is provided a media library apparatus, which comprises: a transportable media cartridge capable of storing a plurality of storage media; a plurality of library units, each of the library units being arranged to transport a transportable storage medium between the media cartridge and a media storage section or drive device of the library unit and perform a data write or read operation on any designated storage medium via the drive device; an array controller that activates the plurality of library units in parallel, to perform a data read/write operation on a plurality of storage media as a single integral media group; a cartridge transport mechanism that sequentially transports the media cartridge to predetermined positions corresponding to the library units; and a control device that performs control for passing a predetermined number of the storage medium between the media storage section or drive device of each of the library units and the media cartridge sequentially transported to the predetermined position corresponding to the library unit.

In the inventive media library apparatus, the cartridge transport mechanism sequentially transports the media cartridge, capable of storing a plurality of storage media, to the predetermined positions confronting or corresponding to the library units. As the media cartridge is thus sequentially transported to the predetermined positions, the library units each receive or send the predetermined number of the storage medium from or to the media cartridge. More specifically, in each of the library units, the predetermined number of the storage medium, taken out from among those stored in the media cartridge, is passed from the cartridge to the media storage section or drive device, or the predetermined number of the storage medium is passed from the storage section or drive device to the cartridge. By thus transporting the media cartridge across the plurality of library units, it is possible to pass the predetermined number of the storage medium between each of the library units and the media cartridge. This way, all of the storage media of a same RAID group that are stored dividedly in and across the plurality of library units can be stored together into the same media cartridge allocated to that RAID group, or the storage media of a same RAID group can be delivered to and stored into the individual library units in such a manner as to permit collective management of the disks independently of other storage media of other RAID groups. As a result, a user of the apparatus can collectively manage the storage media of each RAID group just through the use of the media cartridge allocated to that RAID group.

According another aspect of the present invention, there is provided a media library apparatus, which comprises: a transportable media cartridge capable of storing a plurality of storage media; a plurality of library units, each of the library units being arranged to transport a transportable storage medium between the media cartridge and a media storage section or drive device of the library unit and perform a data write or read operation on any designated storage medium via the drive device; an array controller that activates the plurality of library units in parallel, to perform a data read/write operation on a plurality of storage media as a single integral media group; and a control device that performs control for passing a predetermined number of the storage medium between the media storage section or drive device of each of the library units and the media cartridge, only when all of the storage media to be passed between the library units and the media cartridge are of a same media group. With the arrangement that only when all of the storage media to be passed between the library units and the media cartridge have been determined as being of a same media group, the predetermined number of the storage medium is passed between the media storage section or drive device of each of the library units and the media cartridge, the media cartridge can always receive and store only the media belonging to the same RAID group, and the predetermined number of the storage medium can be delivered from the cartridge to each of the library units and stored into the individual library units in such a manner as to permit collective management of the disks independently of other storage media of other RAID groups.

The present invention may be constructed and implemented not only as the apparatus invention as discussed above but also as a method invention. Also, the present invention may be arranged and implemented as a software program for execution by a processor such as a computer or DSP, as well as a storage medium storing such a program. Further, the processor used in the present invention may comprise a dedicated processor with dedicated logic built in hardware, not to mention a computer or other general-purpose type processor capable of running a desired software program.

While the embodiments to be described hereinbelow represent the preferred form of the present invention, it is to be understood that various modifications will occur to those skilled in the art without departing from the spirit of the invention. The scope of the present invention is therefore to be determined solely by the appended claims.

### BRIEF DESCRIPTION OF THE DRAWINGS

For better understanding of the object and other features of the present invention, its preferred embodiments will be described in greater detail hereinbelow with reference to the accompanying drawings, in which:

FIG. 1 is a schematic perspective view showing a general organization of a media library array apparatus in accordance with an embodiment of the present invention;

FIG. 2 is an enlarged perspective view explanatory of a general construction of each one of a plurality of library units in the media library array apparatus shown in FIG. 1;

FIG. 3 is a conceptual diagram explanatory of predetermined management information affixed to a media cartridge and each disk stored in the media cartridge;

FIG. 4 is a flow chart showing an exemplary step sequence of a matching check process performed when the disks are to be introduced from the media cartridge into the media storage section of each of the library units; and

FIG. 5 is a flow chart showing an exemplary step sequence of a matching check process performed when the disks are discharged from the media storage section of each of the library units into the media cartridge.

### DETAILED DESCRIPTION OF THE EMBODIMENTS

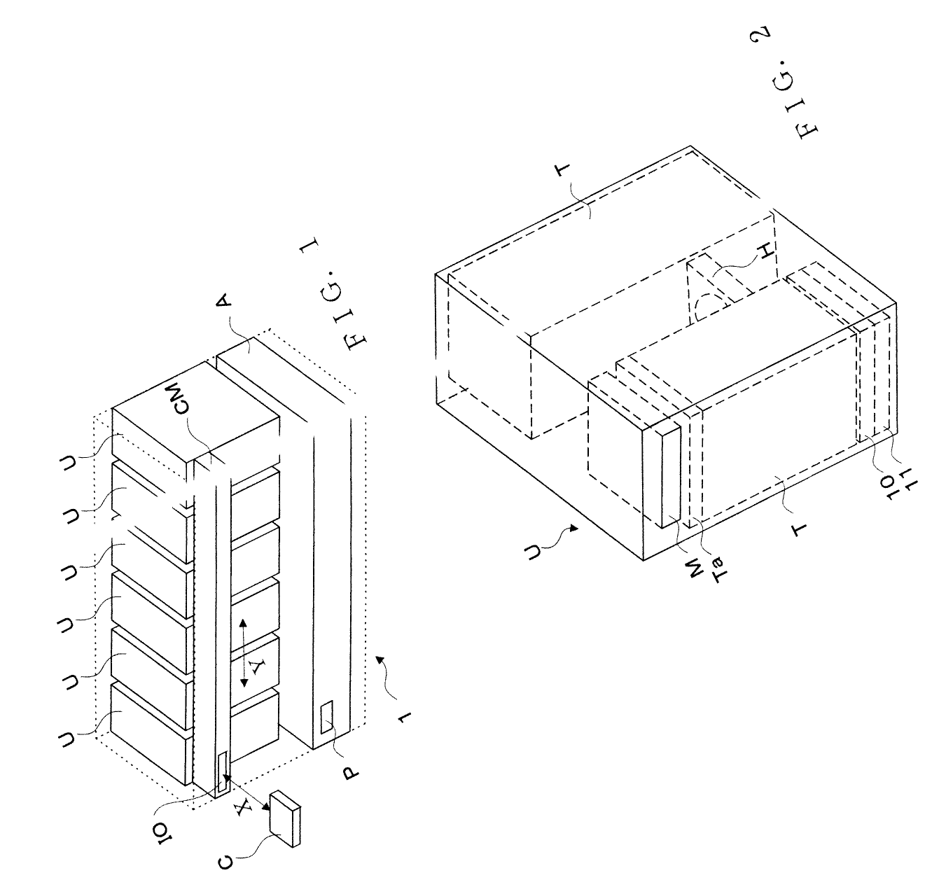

FIG. 1 is a schematic perspective view showing an exemplary general organization of a media library array apparatus in accordance with an embodiment of the present invention. FIG. 2 is an enlarged perspective view showing a general construction of each one of a plurality of library units U (six library units U in the illustrated example) shown in FIG. 1; only one of the library units is shown representatively in FIG. 2 because the other library units U are each similar in construction to the library unit U. Note that the term “storage medium” used in the following description may be construed as referring to a combination of the storage medium and a tray supporting thereon the medium, rather than the storage medium alone.

In response to control instructions, such as data write/read control instructions, given to an array controller A of FIG. 1 from a control panel P or from a not-shown higher-order controller (e.g., personal computer) via a not-shown control interface (such as a SCSI interface), the inventive media library array apparatus concurrently activates the six library units U in a parallel fashion, so as to carry out, at high speed, a write/read operation of desired data on storage media or disks mounted in respective drive devices of the individual library units U. The above-mentioned array controller A employed in the instant embodiment comprises a microcomputer that includes an MPU, a ROM, a RAM, etc. (all not shown), and, in accordance with the control instructions given from the higher-order controller, it performs and controls transportation of the storage media, the data write/read operation based on the parallel activation of the drive devices, etc.

As best seen in FIG. 2, each of the library units U includes a holder/transporter H for holding and transporting a designated storage medium to a designated place within the library unit, a media storage section T having a multiplicity of storage shelves or slots Ta for storing a multiplicity of storage media (only one storage shelf and only one storage medium are shown for simplification of the illustration), and a plurality of drive devices 10 and 11 each provided for writing or reading data to or from a storage medium inserted or mounted therein.

Adjacent to one side of each of the library units U facing an operation area where a human operator can be stationed as necessary, there is provided a cartridge transport mechanism or unit CM extending horizontally across predetermined positions of the individual library units U, as seen in FIG. 1. The cartridge transport unit CM has a cartridge inlet/outlet IO so that a desired media cartridge C can be inserted into or removed from the transport unit CM through the inlet/outlet IO. Specifically, the media cartridge C is inserted into the cartridge transport unit CM along a direction of arrow X, and then the transport unit CM transports the inserted media cartridge C in a horizontal direction as denoted by arrow Y, so as sequentially position the media cartridge C at positions confronting or corresponding to respective mass entry ports M of the library units U. Namely, in the instant embodiment, the cartridge transport unit CM includes a mechanism for transporting a desired media cartridge C in the horizontal (arrow Y) direction, and a mechanism for loading or unloading the media cartridge C into or from the mass entry ports M of the individual library units U. With this arrangement, the desired media cartridge C can be loaded or unloaded into or from the mass entry port M of each of the library units U. The cartridge transport unit CM further includes a means for reading cartridge identification information CI recorded at a predetermined position of the media cartridge C as will be later described.

Generally, the media library array apparatus includes a single housing 1 in which are accommodated all of the above-mentioned plurality of library units U, array controller A and cartridge transport unit CM.

As shown in FIG. 2, each of the library units U is arranged in such a way that in response to a data read/write instruction given from the array controller A (FIG. 1), the library unit U controls its holder/transporter H to take out a desired disk from one of the multiplicity of storage shelves Ta (only one of them is shown for simplification) of the media storage section T and then transports and mounts the taken-out desired disk into one of the drive devices 10 and 11. Then, in the library unit U, the drive device 10 or 11, having the disk thus mounted therein, is controlled to perform a predetermined data read/write operation on the mounted disk. Namely, each of the library units U is constructed to perform the data read/write operation on a desired disk independently of the other library units U. Further, in the inventive media library array apparatus, different data write/read operations can be performed concurrently on disks of a plurality of RAID groups, by causing the plurality of drive devices 10 and 11 of the individual library units U in a parallel fashion. Further, in the instant embodiment, the mass entry port M of each of the library units U is formed into such a shape and size that one media cartridge C having a plurality of disks stored therein can be inserted or removed into or from the mass entry port M. More specifically, the media cartridge C with the plurality of disks stored therein is transported, by the cartridge transport unit CM, sequentially to the individual library units U so that the holder/transporter H of each of the library units U takes out one of the disks from the media cartridge C and then transports the taken-out disk to one of the drive devices 10 and 11; thus, all of the disks stored in the cartridge transport unit CM can be driven (written or read) by the respective drive devices of the library units U.

It should be appreciated that the media library array apparatus of the present invention is not limited to the above-described embodiment. For example, the mechanism for inserting or removing the media cartridge C into or from the mass entry port M and the means for reading the cartridge identification information CI may be provided in each of the library units U, rather than in the cartridge transport unit CM. However, providing such a cartridge inserting/removing mechanism and cartridge-identification-information reading means in the cartridge transport unit CM as in the above-described embodiment is more advantageous in that even library units constructed in the conventional manner can be used directly as the library units U of the inventive media library array apparatus. Further, each of the library units U may be removably installed in the media library array apparatus in such a manner that the entire library unit U can be replaced with another one whenever necessary. Although the media library array apparatus of the invention is shown and described as including a total of six library units U, it may of course include any other plurality of library units than six. Further, whereas the media library array apparatus of the invention is shown and described as including the holder/transporter H in each of the library units U, only one such holder/transporter H may be provided in the entire media library array apparatus for shared use among the library units U. Further, although each of the library units U is shown and described here as including two drive devices 10 and 11, it may be equipped with at least one drive device.

Further, the embodiment of the present invention has been described above in relation to the case where the mass entry port M of each of the library units U is arranged to allow the media cartridge C to be inserted or removed into or from the port M and where the holder/transporter H of each of the library units U is unable to transport any one of the disks from the cartridge C to the interior of the library unit U or from the interior of the library unit U to the cartridge C (i.e., introduction/discharge of a designated disk into/from the library unit U is not permitted) unless the media cartridge C is first deposited from the transport unit CM into the mass entry port M. However, the present invention is not so limited; that is, each of the library units U may be arranged in such a manner that the holder/transporter H can directly take out and transport one of the disks from the media cartridge C located in the cartridge transport unit CM, without having to take out the cartridge C from the transport unit CM and deposit the cartridge C into the mass entry port M prior to the transportation by the holder/transporter H.

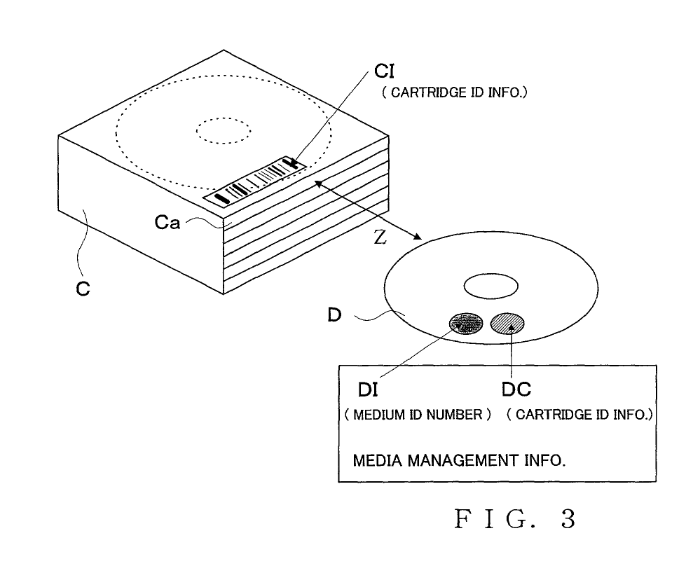

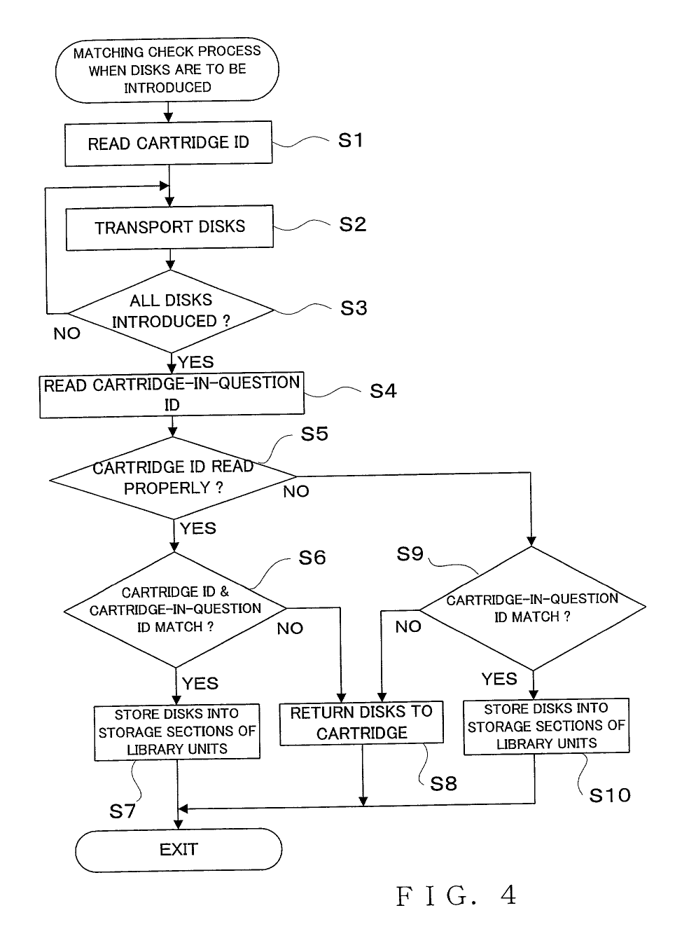

The following paragraphs describe predetermined management information recorded on each media cartridge C and disk employed in the media library array apparatus of the present invention. FIG. 3 is a conceptual diagram explanatory of predetermined management information affixed to each media cartridge C and each disk D to be stored in the media cartridge C. Note that in the illustrated example of FIG. 3, the media cartridge C is designed for use in the media library array apparatus capable of including up to six library units U as shown in FIG. 1; that is, the media cartridge C of FIG. 3 has six horizontal storage slots Ca. Further, for simplicity of illustration, FIG. 3 shows only one disk D as taken out from the media cartridge C.

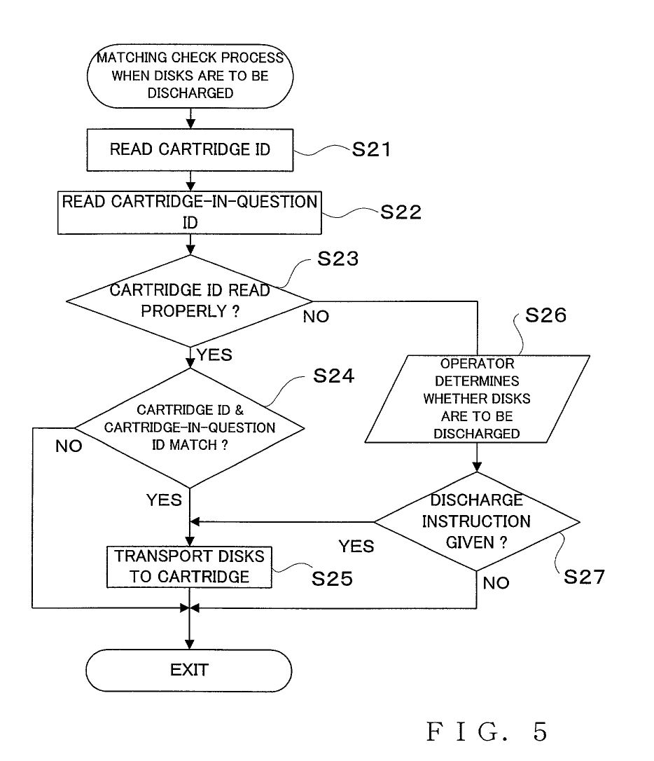

In the media library array apparatus, there is a need to collectively manage a predetermined plurality of the disks D, belonging to a same RAID (Redundant Array of Inexpensive Disks) group, as an integral disk group that is to be processed together. Thus, according to the most important aspect of the present invention, only the disks D of a same RAID group are stored in the respective horizontal storage slots Ca of the media cartridge C, so that every instructed data read/write operation is performed on the disks D belonging to a same RAID group. More specifically, because, in the media library array apparatus of FIG. 1, the disks D stored in the respective horizontal storage slots Ca of the media cartridge C are distributively introduced into the individual library units U one by one, prestoring only the disks D of a same RAID group in a same media cartridge C permits collective management of the disks D of the same RAID group just through the use of the same media cartridge C; to this end, a different media cartridge C may be provided for each RAID group handled in the library apparatus. For this purpose, each time the disks D are loaded or unloaded into or from the media cartridge C, it is necessary to check to see whether the disks D stored in the storage slots Ca of the media cartridge C belong to a same RAID group, as will be later described in detail in relation to cartridge loading and unloading processes of FIGS. 4 and 5. Thus, the instant embodiment is arranged to, on the basis of the management information affixed to the cartridge C and each of the disk D, check a match in RAID group name (or number) between the disks D designated as objects of loading or unloading into or from the media cartridge C, i.e. ascertain whether or not all the disks D designated as objects of loading or unloading belong to a same RAID group.

More specifically, the media cartridge C has cartridge identification information CI affixed to a predetermined position thereof so that the reading means provided, for example, in the cartridge transport unit CM can read the recorded cartridge identification information CI. Here, the cartridge identification information CI is information for identifying the RAID group to which the media cartridge C is allocated; different cartridge identification information CI is set for each RAID group. Although the cartridge identification information CI is shown in FIG. 3 as bar code affixed to the upper surface of the media cartridge C, the present invention is not so limited.

Each of the disks D handled in the media library array apparatus of the invention has media management information recorded on an information recording area thereof, and this media management information includes cartridge-in-question identification information DC and medium identification number DI. The cartridge-in-question identification information DC recorded on the disk D is information indicative of a particular RAID group which the disk D belongs to, and thus different cartridge-in-question identification information DC is recorded for each RAID group. The medium identification number DI is information identifying a specific one of the disks D belonging to the same RAID group, and different medium identification number DI is recorded for each disk D. For instance, at the predetermined position of the media cartridge C having stored therein six disks D belonging to RAID group “A”, bar code representative of “A” is recorded as the cartridge identification information CI, in which case “A-1”, “A-2”, . . . , “A-6” are recorded, as the media management information DI, on the respective disks D stored in the media cartridge C; that is, “A” is recorded as the cartridge-in-question identification information DC, and “1” to “6” are recorded as the medium identification numbers DI.

To manage RAID groups on a cartridge-by-cartridge basis in the above-described inventive media library array apparatus, it is necessary to perform, at the time of loading/unloading of the disk C to/from the media cartridge C, a matching check to see whether or not all the disks D stored in the respective storage slots Ca of the media cartridge C belong to a same RAID group. Thus, examples of the matching check of the disks D stored in the media cartridge C will be described below; more specifically, a description will be made about a matching check process performed when the disks D are to be introduced from the media cartridge C into each of the library units U and a matching check process performed when the disks D are discharged from each of the library units U into the media cartridge C.

FIG. 4 is a flow chart showing an exemplary step sequence of the matching check process performed when the disks D are to be introduced from the media cartridge C into the media storage section T of each of the library units U, and FIG. 5 is a flow chart showing an exemplary step sequence of the matching check process performed when the disks D are discharged from the media storage section T of each of the library units U into the media cartridge C. These matching check processes are started up when a predetermined condition has been met, e.g. when the array controller A has received, from the higher-order controller, control panel P or the like, an instruction for introducing the disks D from the media cartridge C into the media storage section T of each of the library units U or an instruction for discharging the disks D from the media storage section T of each of the library units U into the media cartridge C. Namely, via the higher-order controller, control panel P or the like, the human operator gives a processing instruction for storing desired disks D into the media library array apparatus or for removing desired disks D from the media library array apparatus.

First, the matching check process performed when the disks D are to be introduced from the media cartridge C into the media storage section T will be described with reference to FIG. 4. Namely, once one media cartridge C having stored therein a predetermined number of the disks D is inserted from the operation area into the cartridge transport unit CM through the inlet/outlet IO (along the arrow X direction of FIG. 1), the reading means provided in the cartridge transport unit CM reads the cartridge identification information CI affixed to the inserted media cartridge C, at step S1. After completion of the reading of the cartridge identification (ID) information CI, the matching check process proceeds to step S2, where the disks D stored in the media cartridge C are transported, one by one, to the drive devices 10 or 11 of the individual library units U via the cartridge C and holder/transporters H of the library units U. Namely, the media cartridge C is horizontally transported, by the cartridge transport unit CM, sequentially to the positions confronting the respective mass entry ports M of the library units U (see arrow Y direction of FIG. 1). More specifically, each time the media cartridge C is transported to one of the positions confronting the mass entry ports M, the cartridge transport unit CM temporarily stop the cartridge C at that confronting position, so as to deposit the cartridge C into the mass entry port M of the library unit U in question. Once the media cartridge C is deposited in the mass entry port M, the holder/transporter H of the library unit U in question takes out one of the disks D from the media cartridge C and transports and mounts the taken-out disk D into one of the drive devices 10 and 11. After that, the cartridge transport unit CM takes out the media cartridge C from the mass entry port M, and then horizontally transports the cartridge C to the position confronting the mass entry port M of another or next library unit U so that another one of the disks D is introduced from the media cartridge C into the next library unit U and mounted into the drive device 10 or 11 of that library unit U. This way, the operation of step S2 for introducing and mounting the disk D to the drive device 10 or 11 is repeated until all the disks D stored in the media cartridge C have been introduced into the individual library units U of the array apparatus, one disk per library unit, i.e. until an affirmative (YES) determination is made at step S3.

Once it has been determined at step S3 that all the disks D stored in the media cartridge C have been introduced into the individual library units U, the process goes on to step S4, in order to read the cartridge-in-question identification (ID) information DC recorded on the disks D currently mounted in the drive devices 10 or 11 of the individual library units U. Then, at step S5, a determination is made as to whether or not the cartridge identification information CI has been read properly through the reading of the cartridge identification information CI at step S1 above. If the media cartridge C has no cartridge identification information CI affixed thereto, or if the cartridge identification information CI affixed to the cartridge C could not be read accurately through the reading of the cartridge identification information CI at step S1, a negative (NO) determination is made at step S5, so that the check process of FIG. 4 branches to step S9. At step S9, it is determined whether or not the cartridge-in-question identification information DC read from the individual disks D matches or coincides with each other. If the cartridge-in-question identification information DC read from the individual disks D matches each other (YES determination at step 9), it is judged that the disks D currently mounted in the drive devices 10 or 11 of the library units U belong to a same RAID group, and the process goes to step S10. At step S10, the disk D, in each of the library units U, is transported from the drive device 10 or 11 to the media storage section T for storage therein, at step S10. If, on the other hand, the cartridge-in-question identification information DC read from the individual disks D does not match each other (NO determination at step 9), it is judged that the disks D currently mounted in the drive devices 10 or 11 of the library units U do not belong to a same RAID group, and the process further branches to step S8. At step S8, the cartridge transport unit CM sequentially transports the media cartridge C to the positions confronting the library units U so that in each of the library units U, the disk D is transported from the drive device 10 or 11 back to the cartridge C for storage therein; that is, in this case, the disks D are caused to return to the media cartridge C without being stored in the media storage sections T of the individual library units U.

If the cartridge identification information CI has not been read properly from the inserted media cartridge C as determined at step S5, a determination is made at step S6 as to whether there is a match between the cartridge identification information CI affixed to the cartridge C and read at step S1, and the cartridge-in-question identification information DC recorded on the individual disks D and read at step S4. If the cartridge identification information CI affixed to the cartridge C and the cartridge-in-question identification information DC recorded on the disks D matches or coincides with each other (YES determination at step S6), it is judged that all the disks D currently mounted in the drive devices 10 or 11 of the library units U belong to a same RAID group, so that in each of the library units U, the disk D is transported from the drive device 10 or 11 to the media storage section T for storage therein, at step S7. If, on the other hand, the cartridge identification information CI affixed to the media cartridge C and the cartridge-in-question identification information DC recorded on the disks D does not match each other (NO determination at step S6), it is judged that all the disks D currently mounted in the drive devices 10 or 11 of the library units U do not belong to a same RAID group, and the process further branches to step S8. At step S8, as noted earlier, the cartridge transport unit CM sequentially transports the media cartridge C to the positions confronting the library units U so that in each of the library units U, the disk D is returned from the drive device 10 or 11 to the cartridge C for storage therein.

By thus checking a match in RAID group name or number between the disks D to be introduced from the media cartridge C into the media storage sections T of the individual library units U, the instant embodiment of the present invention can collectively manage the disks D of the same RAID group just through the use of the cartridge C allocated to the RAID group (i.e., storing only the disks D of the same RAID group).

The embodiment of the present invention has been described as reading the cartridge-in-question identification information DC recorded on the disks D only after all of these disks D have been introduced from the cartridge C into the drive devices 10 or 11 of the individual library units U (see steps S2 to S4 of FIG. 4). In an alternative, however, the cartridge-in-question identification information DC recorded on the disks D may be read as the disks D are sequentially introduced, one by one, from the cartridge C into the drive devices 10 or 11 of the individual library units U; that is, the cartridge-in-question identification information DC recorded on each of the disks D may be read immediately as the disk D is introduced from the cartridge C into the drive device 10 or 11 of any one of the library units U.

Next, a description will be made about the matching check process performed when the disks D are discharged from the media storage section T of each of the library units U into the media cartridge C, with reference to FIG. 5. Namely, once an empty media cartridge C having no disk D stored therein is inserted from the operation area into the cartridge transport unit CM (along the arrow X direction of FIG. 1), the reading means provided, for example, in the cartridge transport unit CM reads the cartridge identification information CI affixed to the inserted media cartridge C, at step S21. After completion of the reading of the cartridge identification information CI, the check process proceeds to step S22, in order to read the cartridge-in-question identification information DC recorded on the disks D currently mounted in the drive devices 10 or 11 of the individual library units U. Then, at step S23, a determination is made as to whether or not the cartridge identification information CI has been read properly from the inserted empty media cartridge C through the reading of the cartridge identification information CI at step S21 above. If the inserted empty media cartridge C has no cartridge identification information CI affixed thereto, or if the cartridge identification information CI affixed to the media cartridge C could not be read accurately from the inserted empty media cartridge C, then a negative (NO) determination is made at step S23, so that the check process of FIG. 5 branches to step S26, where the human operator determines whether or not the disks D currently mounted in the drive devices 10 or 11 should be discharged from the library units U and gives a disk discharge instruction if it has been determined that the disks D should be discharged from the library units U. At step S27, it is ascertained whether or not the user has given the disk discharge instruction. If the user has given no disk discharge instruction (NO determination at step S27), each of the disks D mounted in the drive devices 10 or 11 is returned from the drive device 10 or 11 to the media storage section T from which the disk D was taken out earlier, instead of being transported from the drive devices 10 or 11 into the empty media cartridge C. If, on the other hand, the user has given the disk discharge instruction (YES determination at step S27), the process goes to step S25, where all of the disks D are transported from the drive devices 10 or 11 into the empty media cartridge C for storage therein; namely, the disks D are compulsorily discharged from the library units U.

If, on the other hand, the cartridge identification information CI has been read properly from the inserted empty media cartridge C as determined at step S23, a determination is made at next step S24 as to whether there is a match between the cartridge identification information CI affixed to the cartridge C and read at step S21, and the cartridge-in-question identification information DC recorded on the individual disks D and read at step S22. If the cartridge identification information CI affixed to the cartridge C and the cartridge-in-question identification information DC recorded on the disks D matches or coincides with each other (YES determination at step S24), it is judged that all the disks D currently mounted in the drive devices 10 or 11 of the library units U belong to a same RAID group, so that in each of the library units U, the disk D is transported from the drive device 10 or 11 to the empty media cartridge C for storage therein, at step S25. If, however, the cartridge identification information CI affixed to the cartridge C and the cartridge-in-question identification information DC recorded on the disks D does not match each other (NO determination at step S24), it is judged that all the disks D currently mounted in the drive devices 10 or 11 of the library units U do not belong to a same RAID group, so that each of the disks D mounted in the drive devices 10 or 11 is returned from the drive device 10 or 11 to the media storage section T from which the disk D was taken out earlier, instead of being transported from the drive devices 10 or 11 into the empty media cartridge C.

Because the matching check process of FIG. 5 can reliably ensure a match between the disks D to be discharged from the individual library units U into the media cartridge C in the above-described manner, only the disks D belonging to a same RAID group can be stored into the media cartridge C allocated to that RAID group.

Note that when the disks D are compulsorily discharged via the affirmative determination of step S27 and operation of step S25, there may be no complete match between the disks D to be stored into the media cartridge C. However, in this case, because the human operator can recognize that the compulsory discharge instruction has been given, it is only necessary for the human operator to take out the media cartridge C and ascertain visually or otherwise that the disks C in the taken-out media cartridge C are of a same RAID group.

In summary, the present invention is characterized in that each media cartridge always stores therein only a plurality of storage media belonging to a same RAID group and the storage media are introduced/discharged into/from an array of library units just through the use of such a media cartridge. With such characteristic arrangements, the present invention can collectively manage the storage media belonging to the same RAID group on a cartridge-by-cartridge basis.

What is claimed is:

1. A media library apparatus comprising:
a transportable media cartridge capable of storing a plurality of storage media;
a plurality of library units, each of said library units being arranged to transport a transportable storage medium between said media cartridge and a media storage section or drive device of said library unit and perform a data write or read operation on any designated storage medium via the drive device;
an array controller that activates said plurality of library units in parallel, to perform a data read/write operation on a plurality of storage media as a single integral media group;
a cartridge transport mechanism that sequentially transports said media cartridge to predetermined positions corresponding to said library units; and
a control device that performs control for passing a predetermined number of the storage medium between the media storage section or drive device of each of said library units and said media cartridge transported to the predetermined position corresponding to said library unit.

2. A media library apparatus as claimed in claim 1 wherein said array controller performs the data read/write operation on the plurality of storage media, driven in parallel in said plurality of library units, as a RAID group.

3. A media library apparatus comprising:
a transportable media cartridge capable of storing a plurality of storage media;
a plurality of library units, each of said library units being arranged to transport a transportable storage medium between said media cartridge and a media storage section or drive device of said library unit and perform a data write or read operation on any designated storage medium via the drive device;
an array controller that activates said plurality of library units in parallel, to perform a data read/write operation on a plurality of storage media as a single integral media group; and
a control device that performs control for passing a predetermined number of the storage medium between the media storage section or drive device of each of said library units and said media cartridge, only when all of the storage media to be passed between said library units and said media cartridge are of a same media group.

4. A media library apparatus as claimed in claim 3 wherein said array controller performs the data read/write operation on the plurality of storage media, driven in parallel in said plurality of library units, as a RAID group, and
said control device performs the control for passing a predetermined number of the storage medium between the media storage section or drive device of each of said library units and said media cartridge, only when all of the storage media to be passed between said library units and said media cartridge are of a same RAID group.

5. A media library apparatus as claimed in claim 3 wherein predetermined identification information is affixed to said media cartridge, and predetermined media management information is recorded on each of the storage media, and
wherein said control device compares the predetermined identification information affixed to said media cartridge and the predetermined media management information recorded on the storage media, and, only when all of the storage media to be passed between said library units and said media cartridge are of a same RAID group, said control device performs the control for passing a predetermined number of the storage medium between the media storage section or drive device of each of said library units and said media cartridge.

6. A media library apparatus as claimed in claim 5 wherein the predetermined identification information is group information for identifying the RAID group, and the predetermined identification information is affixed in bar code to a predetermined position of said media cartridge.

7. A media library apparatus comprising:
a transportable media cartridge capable of storing a plurality of storage media;
a plurality of library units, each of said library units being arranged to transport a transportable storage medium between said media cartridge and a media storage section or drive device of said library unit and perform a data write or read operation on any designated storage medium via the drive device;
an array controller that activates said plurality of library units in parallel, to perform a data read/write operation on a plurality of storage media as a single integral media group;
a cartridge transport mechanism that sequentially transports said media cartridge to predetermined positions corresponding to said library units; and
a control device that performs control for passing a predetermined number of the storage medium between the media storage section or drive device of each of said library units and said media cartridge, only when all of the storage media to be passed between said library units and said media cartridge are of a same media group.

8. A media library apparatus as claimed in claim 7 wherein said array controller performs the data read/write operation on the plurality of storage media, driven in parallel in said plurality of library units, as a RAID group, and
said control device performs the control for passing a predetermined number of the storage medium between the media storage section or drive device of each of said library units and said media cartridge, only when all of the storage media to be passed between said library units and said media cartridge are of a same RAID group.

9. A media library apparatus as claimed in claim 8 wherein predetermined identification information is affixed to said media cartridge, and predetermined media management information is recorded on the storage media, and
wherein said control device compares the predetermined identification information affixed to said media cartridge and the predetermined media management information recorded on the storage media, and, only when all of the storage media to be passed between said library units and said media cartridge are of a same RAID group, said control device performs the control for passing a predetermined number of the storage medium between the media storage section or drive device of each of said library units and said media cartridge.

10. A media library apparatus as claimed in claim 9 wherein the predetermined identification information is group information for identifying the RAID group, and the predetermined identification information is affixed in bar code to a predetermined position of said media cartridge.

11. A control method for use with a media library apparatus, said media library apparatus comprising: a transportable media cartridge capable of storing a plurality of storage media; a plurality of library units, each of said library units being arranged to transport a transportable storage medium between said media cartridge and a media storage section or drive device of said library unit and perform a data write or read operation on any designated storage medium via the drive device; an array controller that activates said plurality of library units in parallel, to perform a data read/write operation on a plurality of storage media as a single integral media group; and a cartridge transport mechanism that transports said media cartridge, said control method comprising the steps of:
causing said cartridge transport mechanism to sequentially transport said media cartridge to predetermined positions corresponding to said library units; and
performing control for passing a predetermined number of the storage medium between the media storage section or drive device of each of said library units and said media cartridge sequentially transported to the predetermined position corresponding to said library unit.

12. A control method for use with a media library apparatus, said media library apparatus comprising: a transportable media cartridge capable of storing a plurality of storage media; a plurality of library units, each of said library units being arranged to transport a transportable storage medium between said media cartridge and a media storage section or drive device of said library unit and perform a data write or read operation on any designated storage medium via the drive device; and an array controller that activates said plurality of library units in parallel, to perform a data read/write operation on a plurality of storage media as a single integral media group,
said control method comprising a step of performing control for passing a predetermined number of the storage medium between the media storage section or drive device of each of said library units and said media cartridge, only when all of the storage media to be passed between said library units and said media cartridge are of a same media group.

13. A control method for use with a media library apparatus, said media library apparatus comprising: a transportable media cartridge capable of storing a plurality of storage media; a plurality of library units, each of said library units being arranged to transport a transportable storage medium between said media cartridge and a media storage section or drive device of said library unit and perform a data write or read operation on any designated storage medium via the drive device; an array controller that activates said plurality of library units in parallel, to perform a data read/write operation on a plurality of storage media as a single integral media group; and a cartridge transport mechanism that transports said media cartridge, said control method comprising the steps of:
causing said cartridge transport mechanism to sequentially transport said media cartridge to predetermined positions corresponding to said library units; and
performing control for passing a predetermined number of the storage medium between the media storage section or drive device of each of said library units and said media cartridge, only when all of the storage media to be passed between said library units and said media cartridge are of a same media group.
